(19) United States
(12) Patent Application Publication
(10) Pub. No.: US 2025/0178113 A1
(43) Pub. Date: Jun. 5, 2025

(54) HYBRID CHARGERS AND PORTABLE HYBRID WELDING-TYPE SYSTEMS

(71) Applicant: Illinois Tool Works Inc., Glenview, IL (US)

(72) Inventors: Beau Gellings, North Fond du Lac, WI (US); Joseph C. Schneider, Appleton, WI (US)

(21) Appl. No.: 18/958,300

(22) Filed: Nov. 25, 2024

Related U.S. Application Data
(60) Provisional application No. 63/604,808, filed on Nov. 30, 2023.

(51) Int. Cl. B23K 9/10

(52) U.S. Cl. CPC B23K 9/1068

(57) ABSTRACT

Disclosed example hybrid welding-type systems include: a welding-type power supply configured to convert input power to welding-type power, the welding-type power supply comprising an input connector configured to receive the input power; and a hybrid charger configured to connect to the input connector of the welding-type power supply to supply the input power to the welding-type power supply using at least one of AC input power to the hybrid charger or DC input power from an energy storage device connected to the hybrid charger, wherein the energy storage device and the hybrid charger are each connectable to the same input connector.

### RELATED APPLICATIONS

The present application claims the benefit of U.S. Provisional Patent Application Ser. No. 63/604,808, filed Nov. 30, 2023, entitled “HYBRID chargers AND portable hybrid welding-type systems.” The entirety of U.S. Provisional Patent Application Ser. No. 63/604,808 is expressly incorporated herein by reference.

### FIELD OF THE DISCLOSURE

This disclosure relates generally to welding systems, and more particularly to hybrid chargers and portable hybrid welding-type systems.

### BACKGROUND

Conventional welding power supplies are limited to their rated output. In some cases, battery-assisted systems have been used to increase the capacity of welding power supplies. However, conventional battery assisted systems are either integrated with the welding power supply or require the welding power supply to be reconfigured between charging the battery and welding.

### SUMMARY

Hybrid welding systems and portable hybrid welding modules are disclosed, substantially as illustrated by and described in connection with at least one of the figures, as set forth more completely in the claims.

### BRIEF DESCRIPTION OF THE DRAWINGS

FIG. 1 is a block diagram of an example hybrid welding-type system in accordance with aspects of this disclosure.

FIG. 2 is a block diagram of an example arrangement of the welding-type power supply and hybrid charger of FIG. 1.

FIG. 3 is a block diagram of another example arrangement of the welding-type power supply and the hybrid charger of FIG. 1, involving energy storage devices.

FIG. 4 is a block diagram of another example arrangement of the welding-type power supply and the hybrid charger of FIG. 1, involving multiple energy storage devices.

FIG. 5 is a block diagram of an example arrangement of the hybrid charger and energy storage devices connected to the welding-type power supply of FIG. 1.

FIG. 6 is a block diagram of another example arrangement of a welding-type power supply and multiple hybrid chargers connected to the welding-type power supply.

FIG. 7 illustrates another example hybrid welding system, in which one or more additional arrangements of a hybrid charger and energy storage device(s) can be configured by an operator.

FIG. 8 is a block diagram of another example arrangement of the welding-type power supply and hybrid charger of FIG. 7.

FIG. 9 is a block diagram of another example arrangement of the welding-type power supply and hybrid charger of FIG. 7.

The figures are not necessarily to scale. Where appropriate, similar or identical reference numerals are used to refer to similar or identical elements.

### DETAILED DESCRIPTION

Conventional battery-powered welding systems have either an integrated charger, which requires the welding system to be connected to an AC power source to recharge batteries, or a standalone charger which is incapable of supplying power directly to the welding machine. As a result, conventional battery-powered welding power supply. Conventional battery-powered welding systems that include an integrated charger involve additional charging circuitry and reduce the portability.

Disclosed example hybrid welding systems and hybrid chargers provide a flexible, yet capable, hybrid charger as a supplement to a battery-powered power supply. In disclosed examples, a hybrid charger includes circuitry to deliver welding power from an AC power source (e.g., a mains source, a generator, a battery-powered inverter power source), to charge batteries, and to discharge batteries in combination with the AC power source to boost the welding-type output of the welding-type power supply. In addition, the hybrid charger is selectively connectable to the power supply in place of a battery, such that the hybrid charger can be used to charge batteries separately from use of the battery-powered welding-type power supply to perform welding-type operations using battery power at a different location. In disclosed examples, the hybrid charger connects to the welding-type power supply using the same connection used to connect a battery, such that only one connection may be present on the power supply for either the battery or the hybrid charger to be directly connected.

Using disclosed example power supplies and hybrid chargers, the hybrid charger can be connected to the power supply for easy transport and use of available AC input power, and can also be removed when the operator just increased portability and/or the ability to weld using only batteries (e.g., at remote locations or locations which otherwise do not have readily available AC power). By disconnecting the hybrid charger, the weight of the welding equipment is reduced for carrying and transport.

Disclosed example hybrid welding-type systems include: a welding-type power supply configured to convert input power to welding-type power, the welding-type power supply comprising an input connector configured to receive the input power; and a hybrid charger configured to connect to the input connector of the welding-type power supply to supply the input power to the welding-type power supply using at least one of AC input power to the hybrid charger or DC input power from an energy storage device connected to the hybrid charger, wherein the energy storage device and the hybrid charger are each connectable to the same input connector.

In some examples, the hybrid charger is further configured to charge the energy storage device using the AC input power while the hybrid charger is connected to the input connector of the welding-type power supply. In some example hybrid welding-type systems, the hybrid charger is further configured to charge the energy storage device using the AC input power while the hybrid charger is disconnected from the input connector of the welding-type power supply. In some example hybrid welding-type systems, the hybrid charger includes a second connector configured to connect to the energy storage device. In some example hybrid welding-type systems, the second connector is the same type of connector as the input connector of the welding-type power supply.

Some example hybrid welding-type systems further include a first adapter configured to couple the energy storage device to the input connector. Some example hybrid welding-type systems further include a second adapter configured to couple the energy storage device to the second connector, the second connector being a different type than the input connector of the welding-type power supply. In some example hybrid welding-type systems, the welding-type power supply is configured to receive input via a DC bus, and the hybrid charger and the energy storage device are configured to couple to the DC bus in parallel when the hybrid charger and the energy storage device are coupled to the welding-type power supply via the input connector, the second connector, and the third connector.

In some example hybrid welding-type systems, the energy storage device includes a third connector. In some example hybrid welding-type systems, the third connector is a same type as the second connector. Some example hybrid welding-type systems further include a second energy storage device configured to connect to each of the input connector, the second connector, and the third connector. In some example hybrid welding-type systems, at least one of the second connector or the third connector is configured to expose electrical contacts in response to connection of a device to the second connector or the third connector.

In some example hybrid welding-type systems, the welding-type power supply includes a DC-DC converter circuitry configured to convert the input power from DC to DC welding-type power. In some example hybrid welding-type systems, the hybrid charger is configured to removably mount to the welding-type power supply. In some example hybrid welding-type systems, the energy storage device is configured to removably mount to the welding-type power supply.

In some example hybrid welding-type systems, the hybrid charger includes a user interface configured to output an indication of a charge state of the energy storage device. In some example hybrid welding-type systems, the welding-type power supply includes an inverter configured to convert power from the energy storage device to an AC output.

Some example hybrid welding-type systems further include an energy storage device adapter configured to couple the energy storage device to the input connector of the welding-type power supply. In some example hybrid welding-type systems, the energy storage device adapter is configured to couple a plurality of energy storage devices to the input connector of the welding-type power supply. In some example hybrid welding-type systems, the hybrid charger is configured to charge a plurality of energy storage devices simultaneously using the AC input power.

As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “bidirectional DC-DC converter” refers to any bidirectional circuitry topology that converts voltage down (e.g., bucks) in a first direction and converts voltage up (e.g., boosts) in a second direction. Example bidirectional DC-DC converters include buck-boost and/or boost-buck topologies, a SEPIC converter, a Ćuk converter, or the like.

As used herein, a “circuit” includes any analog and/or digital components, power and/or control elements, such as a microprocessor, digital signal processor (DSP), software, and the like, discrete and/or integrated components, or portions and/or combinations thereof.

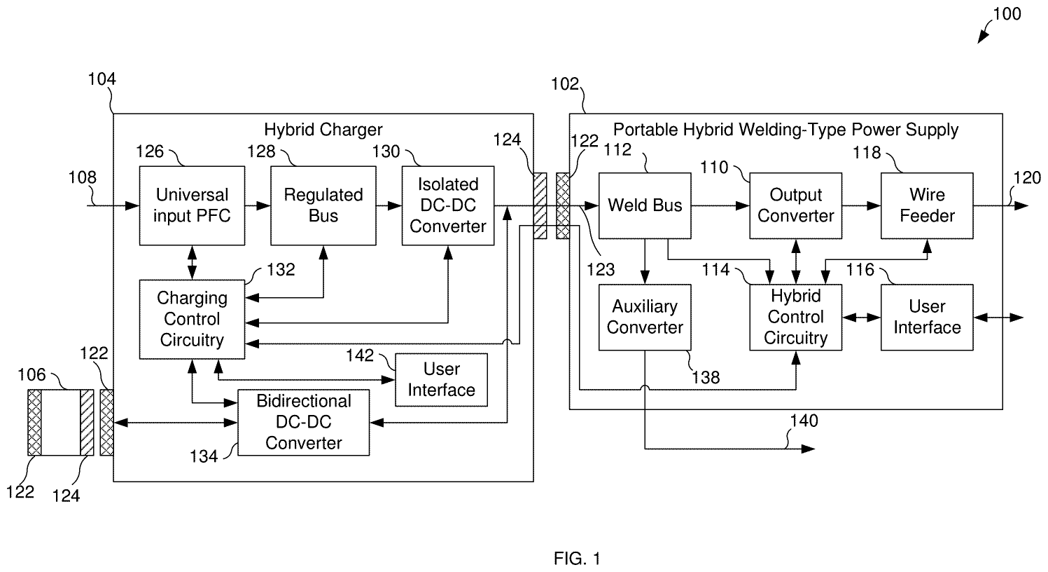

FIG. 1 is a block diagram of an example hybrid welding system 100. The example hybrid welding system 100 of FIG. 1 includes a portable hybrid welding-type power supply 102 and a hybrid charger 104. The portable hybrid welding-type power supply 102 and a hybrid charger 104 may be connected and disconnected as desired to enable the portable hybrid welding-type power supply 102 to reduce the weight of the system 100 for welding operations. In addition to the power supply 102 and a hybrid charger 104, the hybrid welding system 100 includes one or more energy storage devices 106.

The example energy storage device 106 is a battery, but may be implemented using an ultracapacitor, a supercapacitor, and/or any other type of energy storage which is capable of sufficient power density and discharge rates to support the desired weld operations.

The portable hybrid welding-type power supply 102 includes an output converter 110, a weld bus 112, a hybrid control circuitry 114, a user interface 116, and a wire feeder 118.

The output converter 110 is a circuitry that converts direct current (DC) power from the weld bus 112 to welding-type output power 120. For example, the output converter 110 may include a buck converter, a boost converter, a buck-boost converter, a boost-buck converter, a forward converter, a flyback converter, a Ćuk converter, and/or any other type of isolating or non-isolating DC-DC converter. The weld bus 112 may be a regulated DC bus or an unregulated DC bus. The output converter 110 receives power from the weld bus 112, which is supplied by one or more input sources as disclosed in more detail below. The hybrid control circuitry 114 controls the output converter 110 to output the welding-type output power 120 at the desired voltage and/or current (e.g., based on a setpoint), which may be based on closed-loop voltage and/or current control.

The example wire feeder 118 includes a wire feed motor to provide electrode wire to the welding operation (e.g., when the welding operation involves a wire feeder, such as when gas metal arc welding, flux cored arc welding, etc.). When the welding operation involves a wire feeder, the hybrid control circuitry 114 controls the wire feeder 118. In the example of FIG. 1, the wire feeding derives power from the welding-type output power 120.

The user interface 116 enables input to the portable hybrid welding-type power supply 102 and/or output from the portable hybrid welding-type power supply 102 to a user. The hybrid control circuitry 114 may indicate the state of charge of the energy storage device(s) 106 and/or a mode of operation, such as a battery charging mode, an external power welding mode (e.g., welding mode), a combination welding-charging mode, a battery powered welding mode (e.g., discharge mode), or a hybrid welding mode (e.g., welding boost mode), of the portable hybrid welding-type power supply 102 via the user interface 116. The user interface 116 may indication of a charge state of the energy storage devices 106 that are attached to the power supply 102, either directly or via an intermediate device (e.g., the charger 104, another energy storage device 106). In some examples, the hybrid charger 104 may include a similar or different user interface 116 to convey the charging states and/or charge states of the connected energy storage device(s) 106.

The weld bus 112 is coupled to one or more sources of DC input power, including the hybrid charger 104 and/or one or more energy storage devices 106. The weld bus 112 may receive DC input power 123 from the hybrid charger 104 and/or from battery power converted by the bidirectional DC-DC converter 134, and/or a combination of the DC input power 123 and the converted battery power. To connect the power supply 102 to the source(s) of input power, the power supply 102 includes an input connector 122. Each of the hybrid charger 104 and the energy storage device 106 includes a complementary connector 124 to electrically couple and, in some examples, mechanically couple to the input connector 122 of the power supply 102.

In the example of FIG. 1, the power supply 102 includes one input connector 122, such that only one of the hybrid charger 104 or the energy storage device 106 is directly connected to the input connector 122 at a time. However, in other examples, the power supply 102 may include two or more input connectors 122 to allow for both the energy storage device 106 and the hybrid charger 104, or multiple hybrid chargers 104, to provide power to the power supply 102.

The example input connector 122 of FIG. 1 provides both mechanical connection and electrical connection. One such connector may include a sliding mechanical connection that both latches the complementary connector 124 to the input connector 122 and establishes an electrical connection at a coupled position. For example, the complementary connector 124 and the input connector 122 may be implemented similarly to a battery connection on a cordless power tool. Alternatively, the input connector 122 may be implemented as a receptacle and the complementary connector 124 may be implemented as a cord and plug. Other types of complementary connectors may also be used.

To provide DC power to the power supply 102, the hybrid charger 104 may convert receives and converts AC input power 108 from a power source such as a generator, a mains power supply, and/or any other power source. The hybrid charger 104 may be configured to receive 120 VAC, 240 VAC, and/or any other AC input voltages, and may be configured to receive single phase and/or three-phase power. The example hybrid charger 104 converts the AC input power 108 to output the DC input power 123 to the portable hybrid welding-type power supply 102 via the connectors 122, 124. The hybrid charger 104 includes an input power factor correction (PFC) circuitry 126, a regulated bus 128, and an isolated DC-DC converter 130, and further includes a charging control circuitry 132 to control the PFC circuitry 126 and the isolated DC-DC converter 130. The hybrid charger 104 is capable of providing welding-type power to the portable hybrid welding-type power supply 102 via the PFC circuitry 126 and the isolated DC-DC converter 130.

The power factor correction circuitry 126 performs power factor correction on the AC input power 108. The charging control circuitry 132 controls the power factor correction circuitry 126, the regulated bus 128, and/or the isolated DC-DC converter 130 in the hybrid charger 104. The charging control circuitry 132 may receive and/or transmit feedback and/or commands from the hybrid control circuitry 114 for controlling the portable hybrid welding-type power supply 102 and/or the hybrid charger 104. For example, the connectors 122, 124 may include communication connections to allow the hybrid control circuitry 114 to communicate with the charging control circuitry 132.

The power factor correction circuitry 126 outputs power factor corrected and regulated power to the regulated bus 128, which is input to the isolated DC-DC converter 130. When the hybrid charger 104 is connected to the portable hybrid welding-type power supply 102, the isolated DC-DC converter 130 outputs the DC input power 123 to the portable hybrid welding-type power supply 102 via connectors 122, 124.

In addition to outputting the DC input power 123 to the power supply 102, the hybrid charger 104 may output all or a portion of the DC input power 123 to the energy storage device 106 connected to an input connector 122 of the hybrid charger 104. The example input connector 122 of the hybrid charger 104 is identical or sufficiently similar to the input connector 122 of the power supply 102 such that the energy storage device 106 can be connected to each of the input connectors 122 of the power supply 102 and the hybrid charger 104.

To charge the energy storage device 106, the hybrid charger 104 includes a bidirectional DC-DC converter 134, which also enables the hybrid charger 104 to draw power from the energy storage device 106 to provide additional power to the power supply 102 (e.g., to increase the welding-type output power 120 from the power supply 102). The bidirectional DC-DC converter 134 is a circuitry that converts the DC input power 123 from the isolated DC-DC converter 130 to charge the energy storage device 106, and converts the battery power stored in the energy storage device 106 to converted battery power to output to the DC input power 123 for output to the output converter 110. In the example of FIG. 1, the bidirectional DC-DC converter 134 couples the energy storage device 106 to the DC input power 123 in parallel with the isolated DC-DC converter 130. The charging control circuitry 132 controls the bidirectional DC-DC converter 134 based on whether the energy storage device 106 is to be charged or discharged to provide power to the weld bus 112.

In some other examples, the bidirectional DC-DC converter 134 is coupled to the regulated bus 128, in which case the bidirectional DC-DC converter 134 may also be an isolating DC-DC converter.

The hybrid control circuitry 114 determines whether the hybrid charger 104 is connected to the portable hybrid welding-type power supply 102 based on detecting the DC input power 123, detecting a connection with the hybrid charger 104 via a communications terminal, or detecting an analog or digital signal.

When the hybrid charger 104 is connected to the AC input power 108 and to the energy storage device 106, the hybrid charger 104 may charge the energy storage device 106. The charging control circuitry 132 controls the bidirectional DC-DC converter 134 to convert power from the DC input power 123 to charge the energy storage device 106 and/or controls the bidirectional DC-DC converter 134 to convert power from the energy storage device 106 to provide the converted battery power to the DC input power 123. The hybrid charger 104 may charge connected energy storage devices 106 when the hybrid charger 104 is connected to the power supply 102 and when the hybrid charger 104 is disconnected from the power supply 102. For example, the charging control circuitry 132 controls the bidirectional DC-DC converter 134 to charge the energy storage device 106 when the DC input power 123 is available (e.g., when the hybrid charger 104 is converting the AC input power 108) and at least a portion of the DC input power 123 is available for charging the energy storage device 106 (e.g., the DC input power 123 is not completely consumed by the output converter 110 and/or the wire feeder 118).

Conversely, when the hybrid charger 104 is connected to the power supply 102, the energy storage device 106 is connected to the hybrid charger 104, and energy is required for welding-type operations in excess of what is available from the AC input power 108, the energy storage device 106 may provide additional power to the portable hybrid welding-type power supply 102 via the bidirectional DC-DC converter 134. For example, the charging control circuitry 132 controls the bidirectional DC-DC converter 134 to convert power from the energy storage device 106 to provide the converted battery power to the DC input power 123.

To determine whether to use supplemental power from the energy storage device 106, the hybrid control circuitry 114 and/or the charging control circuitry 132 determine whether a threshold output of the hybrid charger 104 has been exceeded. For example, the hybrid control circuitry 114 monitors an output current and an output voltage from the output converter 110, a current of the DC input power 123, and/or the voltage of the weld bus 112, and/or the charging control circuitry 132 monitors the output voltage and/or the output current of the DC input power 123. For example, the hybrid charger 104 may determine that DC input power 123 is insufficient to support the commanded voltage and/or current at the output converter 110 while the hybrid charger 104 is connected, and/or the charging control circuitry 132 may identify a voltage droop at the output of the isolated DC-DC converter 130. Based on the output current and/or an output voltage from the output converter 110, a current of the DC input power 123, the voltage of the weld bus 112, and/or a voltage of the DC input power 123 indicating that the demand by the power supply 102 exceeds the power provided by the AC input power 108, the charging control circuitry 132 controls the bidirectional DC-DC converter 134 to convert energy from the energy storage device 106 to provide power to the DC input power 123.

In the example of FIG. 1, the charging control circuitry 132 controls the bidirectional DC-DC converter 134 to provide converted stored power from the energy storage device 106 to the output of the hybrid charger 104 to supplement the DC input power 123. For example, the charging control circuitry 132 may control the bidirectional DC-DC converter 134 to output a converted voltage that is less than a threshold output voltage of the hybrid charger 104. The threshold output voltage may correspond to a nominal voltage of the weld bus 112, less a threshold voltage droop. When the output capacity of the hybrid charger 104 is exceeded, the voltage droop on the weld bus 112 causes the weld bus 112 to decrease below the output voltage (e.g., boosted voltage) of the bidirectional DC-DC converter 134 converting the stored power from the energy storage device 106.

The hybrid control circuitry 114 may also communicate with the charging control circuitry 136 via the connectors 122, 124 to coordinate the power balance from the AC input power 108 and the energy storage device 106 to the power supply 102.

Each of the hybrid charger 104 and the energy storage device 106 are configured to connect to a connector 122 of the power supply 102. In some examples, an adapter may be used to electrically and/or mechanically connect the connector 124 of the energy storage device 106 and/or the hybrid charger 104 to the connector 122. In some examples, an adapter may connect multiple energy storage devices 106 to the input connector 122 in a parallel or serial configuration. In some examples, different adapters may be used to connect the energy storage device 106 to the connector 122 of the power supply 102 than a connector (a same or different connector as the input connector 122) of the hybrid charger 104.

In some examples, the power supply 102 may include an auxiliary converter 138 (e.g., an inverter circuit) to convert power from the weld bus 112 to an AC auxiliary output 140. For example, when the energy storage device 106 is connected to the input connector 122, the auxiliary converter 138 may use the stored energy to provide the AC auxiliary output 140.

In contrast with conventional hybrid welding systems, the electrical and mechanical connection provided by the input connectors 122 and the complementary connector 124 enables multiple arrangements of the power supply 102, the hybrid charger 104, and available energy storage devices 106. In particular, the hybrid charger 104 may be attached to the power supply 102 to provide an AC powered welding-type output when available, and may be detached for improved portability. Furthermore, because the hybrid charger 104 includes charging circuitry (e.g., the bidirectional DC-DC converter 134), the hybrid charger 104 is capable of charging energy storage devices 106 while the power supply 102 is used to perform welding, whether the hybrid charger 104 is connected or disconnected from the welding-type power supply 102.

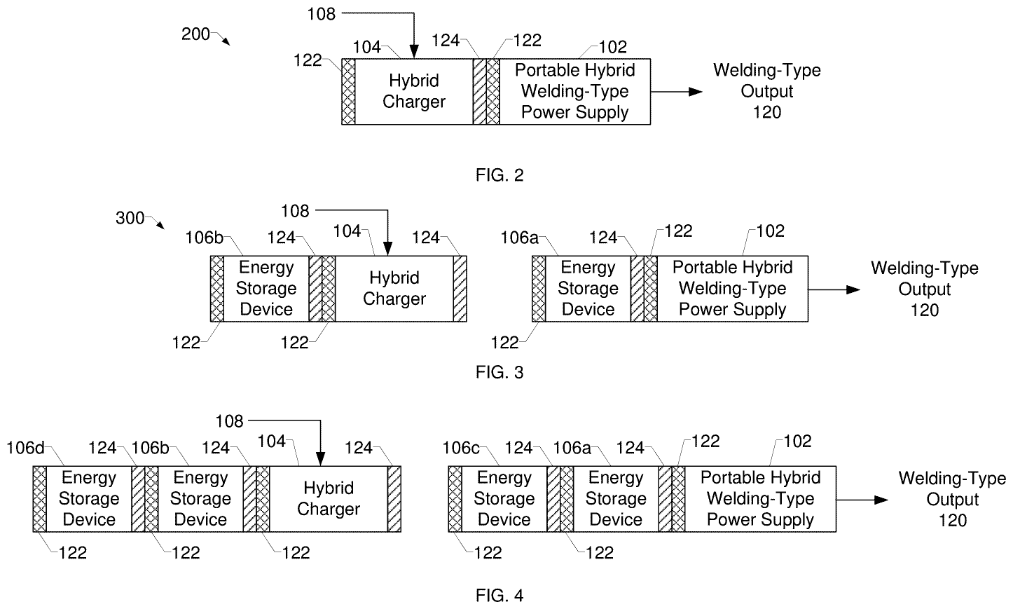

In addition to the complementary connectors 124, each of the example hybrid charger 104 and the energy storage devices 106 may include the input connectors 122 to enable daisy-chaining of hybrid chargers 104 and/or energy storage devices 106 to provide the DC input power 123 to the power supply 102. In some examples, the connectors 122 and the connectors 124 are coupled together in each of the energy storage devices 106, such that the energy storage devices 106 can store or discharge power via the connector 122 of the energy storage device 106, pass through power received via the connector 124 of the energy storage device 106 to the connector 122 (e.g., to supply power from multiple energy storage devices 106 to the power supply 102 and/or to the hybrid charger 104), and/or pass through power received via the connector 122 of the energy storage device 106 to the connector 124 (e.g., to enable charging of multiple energy storage devices 106 by the hybrid charger 104). FIGS. 2-6 illustrate example arrangements of the power supply 102 of FIG. 1 with the hybrid charger 104 and/or one or more energy storage devices 106.

The example hybrid charger 104 may further include a user interface 142 to receive inputs and/or provide outputs to a user. For example, the user interface 142 may include one or more output devices, such as LEDs or other visual indicators, to communicate an operational status of the hybrid charger. For example, the output devices may indicate the presence and/or use of power from one or more energy storage devices 106, the presence and/or use of power from the AC input power 108, whether the charger 104 is outputting power to the power supply 102, and/or whether the charger 104 is charging the energy storage device(s) 106. Additionally or alternatively, the user interface 142 may include one or more input devices to allow the operator to change the operation of the charger 104, such as by enabling or disabling charging of the energy storage device(s) 106, and/or by configuring which energy source(s) 106, 108 are used for outputting DC power to the power supply 102.

FIG. 2 is a block diagram of an example arrangement 200 of the welding-type power supply 102 and hybrid charger 104 of FIG. 1. In the example of FIG. 2, the connector 124 of the hybrid charger 104 is mechanically and electrically connected to the input connector 122 of the power supply 102. The hybrid charger 104 receives the AC input power 108, and outputs DC power to the power supply 102 for conversion to the welding-type output 120.

FIG. 3 is a block diagram of another example arrangement 300 of the welding-type power supply 102 and the hybrid charger 104 of FIG. 1. In the example arrangement 300, the hybrid charger 104 is separated from the power supply 102, and an energy storage device 106a is connected to the power supply 102 via the same input connector 122 of the power supply 102 and the complementary connector 124 of the energy storage device 106a. In such examples, the power supply 102 receives the DC input power 123 from the energy storage device 106a, and the output converter 110 converts the DC input power 123 to the welding-type output 120.

While the first energy storage device 106a powers the power supply 102, the hybrid charger 104 may be used separately and simultaneously to charge a second energy storage device 106b. For example, the bidirectional DC-DC converter 134 of the hybrid charger 104 converts the DC output from the isolated DC-DC converter 130 to charge the energy storage device 106b. The second energy storage device 106b is connected to the input connector 122 of the hybrid charger 104 using the same complementary connector 124 used to connect the energy storage device 106 to the power supply 102.

Each of the example energy storage devices 106a, 106b also includes a complementary connector 124, which allows for attachment of additional energy storage devices to the energy storage devices 106a, 106b (e.g., daisy-chaining). FIG. 4 is a block diagram of another example arrangement 400 of the welding-type power supply and the hybrid charger of FIG. 1, involving multiple energy storage devices 106a-106d. In the example of FIG. 4, each of the energy storage devices 106a, 106b has an additional attached energy storage device 106c, 106d.

The energy storage device 106c is attached to the input connector 122 of the energy storage device 106a. The example power supply 102 may draw power from both of the energy storage devices 106a, 106c to generate the welding-type output 120. In some examples, the mechanical connections between the power supply 102 and the energy storage devices 106a, 106c allows the power supply 102 and the energy storage devices 106a, 106c to be carried or otherwise transported as a single unit, which improves portability of the system.

The energy storage device 106d is attached to the input connector 122 of the energy storage device 106b. The hybrid charger 104 may charge both energy storage devices 106b, 106d simultaneously (e.g., via the bidirectional DC-DC converter 134). In some examples, the hybrid charger 104 may communicate with energy storage management systems within the energy storage devices 106b, 106d to prioritize or otherwise control the charging of the energy storage devices.

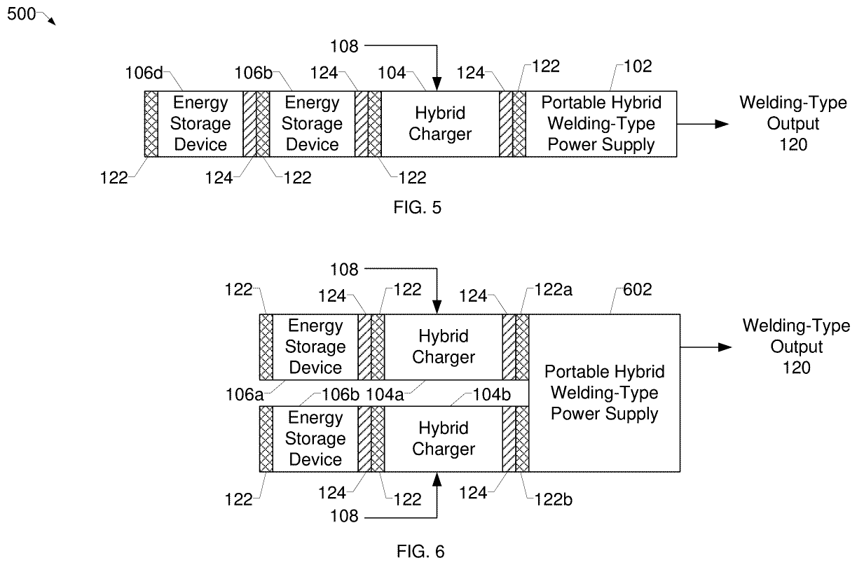

Additionally, the mechanical connections between the hybrid charger 104 and the energy storage devices 106b, 106d allows for the hybrid charger 104 and the energy storage devices 106b, 106d to be easily simultaneously connected to the power supply 102 by disconnecting the energy storage devices 106a, 106c from the power supply 102 and connect the hybrid charger 104 with the attached energy storage devices 106b, 106d to the power supply 102. FIG. 5 is a block diagram of an example arrangement 500 of the hybrid charger 104 and energy storage devices 106b, 106d connected to the welding-type power supply of FIG. 1. In the arrangement 500 of FIG. 5, the hybrid charger 104 may provide DC input power 123 to the power supply 102 from the AC input power 108.

When the AC input power 108 is insufficient to provide the required welding-type output 120, the charging control circuitry 132 may control the bidirectional DC-DC converter 134 to supply additional power from the energy storage devices 106b, 106d. The energy storage devices 106b, 106d may be electrically connected, in parallel or in series, to the power supply 102 via the connectors 122, 124.

Conversely, when the available AC input power 108 is in excess of the power required to support the welding-type output 120, and/or when there is no welding-type output 120, the charging control circuitry 132 may control the bidirectional DC-DC converter 134 to charge either or both of the energy storage devices 106b, 106d.

In some examples, the connectors 124 are configured to cover or block the electrical contacts when not connected to an input connector 122, to reduce or eliminate access to electrical potential by an operator or other personnel.

FIG. 6 is a block diagram of another example arrangement of a welding-type power supply 602 and multiple hybrid chargers 104a, 104b connected to the welding-type power supply 602. Instead of a single input connector, the example welding-type power supply 602 includes two input connectors 122a, 122b. Each of the input connectors 122a, 122b is similar or identical to the input connector 122 of the example power supply 102 of FIG. 1.

The two input connectors 122a, 122b enable connection of multiple hybrid chargers 104a, 104b to the power supply 602. The hybrid chargers 104a, 104b are connected to different sources of AC power 108a, 108b, but may be connected to a same source of AC input power if the AC input power source has sufficient output. The input connectors 122a, 122b each provide DC input power to the output converter 110.

One or more energy storage device 106a, 106b may be connected to each of the hybrid chargers 104a, 104b in a similar manner as illustrated in FIGS. 4 and 5.

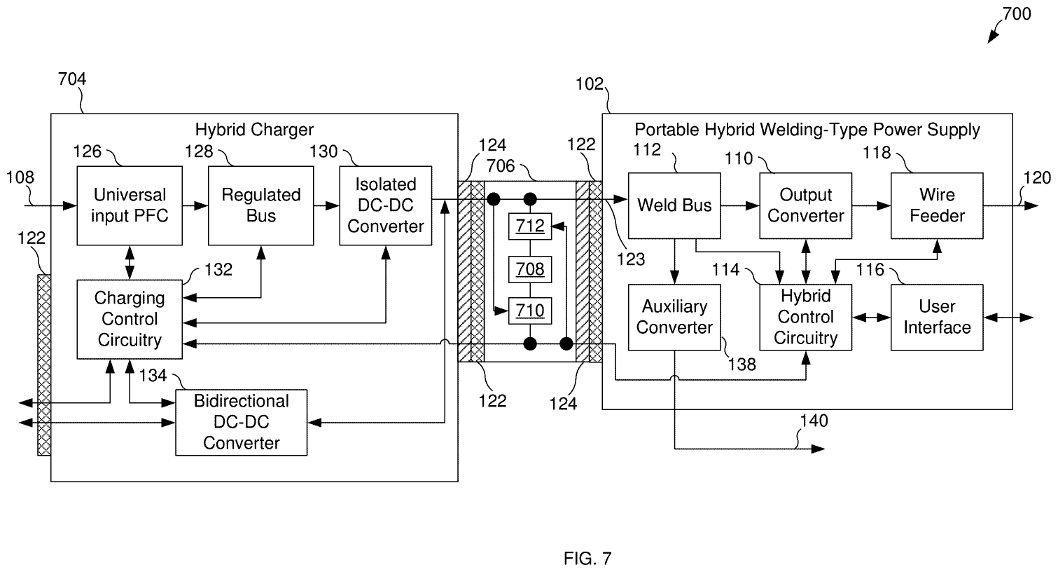

FIG. 7 illustrates another example hybrid welding system 700, in which one or more additional arrangements of a hybrid charger 704 and energy storage device(s) 706 can be configured by an operator. The example hybrid welding system 700 includes the portable hybrid welding-type power supply 102 of FIG. 1 disclosed above, as well as a hybrid charger 704 and one or more energy storage device(s) 706.

The example hybrid charger 704 receives the AC input 108, and includes the example input PFC 126, the regulated bus 128, the isolated DC-DC converter 130, and the charging control circuitry 132 of FIG. 1. For flexibility, the example hybrid charger 704 may further include the bidirectional DC-DC converter 134 to allow for charging of energy storage devices 706 coupled to the input connector 122 of the hybrid charger 704.

The example energy storage devices 706 of FIG. 7 include energy storage cells 708, charging circuitry 710, and output circuitry 712. The energy storage cells 708 include one or more units of chemical, thermal, electrical, and/or other energy storage that may be charged and subsequently discharged to supply power to the power supply 102. The example energy storage device(s) 706 may be coupled to the hybrid charger 704 via either of the connectors 122, 124 of the hybrid charger 704, such that the hybrid charger 704 and the energy storage devices 706 may be connected to the power supply 102 in any desired physical configuration.

The charging circuitry 710 receives power from DC input power 123 via the connector 124 of the hybrid charger 704, and converts the power for storage in the energy storage cells 708. For example, the charging circuitry 710 may include a buck converter, a boost converter, a buck-boost converter, a boost-buck converter, a forward converter, a flyback converter, a Ćuk converter, and/or any other type of isolating or non-isolating DC-DC converter. The charging circuitry 710 may be controlled by the hybrid control circuitry 114 and/or by the charging control circuitry 132, in a similar manner as the control of the bidirectional DC-DC converter 134 in charging mode as described above.

The output circuitry 712 receives power from the energy storage cells 708, and converts the power for output to the weld bus 112 via the connectors 122, 124. For example, the output circuitry 712 may include a buck converter, a boost converter, a buck-boost converter, a boost-buck converter, a forward converter, a flyback converter, a Ćuk converter, and/or any other type of isolating or non-isolating DC-DC converter. The output circuitry 712 may be controlled by the hybrid control circuitry 114 and/or by the charging control circuitry 132, in a similar manner as the control of the bidirectional DC-DC converter 134 in discharge mode as described above.

The connectors 122, 124 of the hybrid system 700 of FIG. 7 may include multiple sets of electrical contacts or terminals to support multi-directional flows of current. For example, the energy storage device(s) 706 may be coupled to a first set of contacts for input of charging power, and coupled to a second set of contacts for output of power. The connectors 122, 124 may further include communications contacts or terminals to provide communication between the hybrid control circuitry 114, the charging control circuitry 132, and/or the energy storage device(s) 706.

In some other examples, the connectors 122, 124 may be divided into separate connectors for different power paths. For example, one set of connectors (e.g., input connectors and complementary connectors) may be configured to provide charging power to connected energy storage devices, a second set of connectors may be configured to provide an output power path to the power supply, and/or a third set of connectors may be configured to establish communications and/or control between connected elements. The different sets of connectors may be configured such that the appropriate connectors are connected to the appropriate power paths based on the order of physical interconnection (e.g., whether the energy storage device is between the hybrid charger and the power supply, or whether the hybrid charger is between the energy storage device and the power supply).

Additionally or alternatively, the charging circuitry 710 and/or the output circuitry 712 may be coupled to the bidirectional DC-DC converter 134 (e.g., via the connector 124 of the hybrid charger 704). In some examples, the hybrid charger 704 may omit the bidirectional DC-DC converter 134 when using the energy storage devices 106 having the charging circuitry 710 and output circuitry 712, and the charging control circuitry 132 controls the charging circuitry 710 and the output circuitry 712. The energy storage device(s) 706 may include device management circuitry to provide communication and/or control of the charging circuitry 710 and the output circuitry 712.

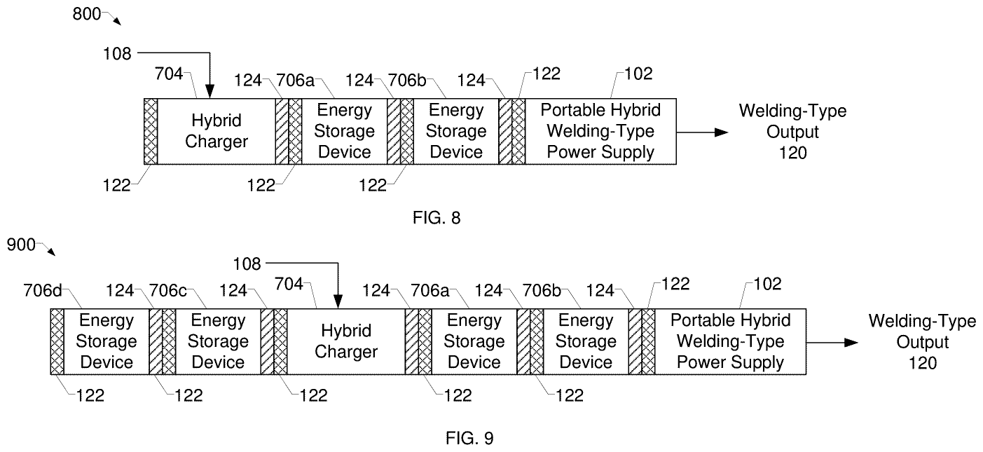

The example hybrid welding system 700 may support any of the configurations illustrated in FIGS. 2-6. Additionally, FIG. 8 is a block diagram of another example arrangement 800 of the welding-type power supply 102 and hybrid charger 704 of FIG. 7. In the example of FIG. 8, multiple energy storage devices 706a, 706b are coupled between the hybrid charger 704 and the power supply 102. The example arrangement 800 of FIG. 8 may operate similarly to the arrangement 500 of FIG. 5, in that the hybrid charger 704 selectively charges the energy storage devices 706a, 706b when excess power is available, and the energy storage devices 706a, 706b are controlled to discharge stored energy to the power supply 102 to boost the welding-type output 120 when the AC input power 108 is insufficient for the desired welding-type output 120.

The example arrangements 800, 900 allow for additional convenience for an operator, by reducing the physical disconnection of energy storage devices from the power supply 102 to allow for connection of the hybrid charger 104 and the energy storage devices to the power supply 102. Instead, the operator may easily and quickly connect the hybrid charger 704 to the energy storage devices 706a, 706b, which are already attached to the power supply 102, to allow for use of the hybrid charger 704 with the hybrid system 700.

FIG. 9 is a block diagram of another example arrangement 900 of the welding-type power supply 102 and hybrid charger 704 of FIG. 7. The arrangement 900 of FIG. 9 is similar to the arrangement 800 of FIG. 8, with the exception that additional energy storage devices 706c, 706d are connected to the input connector 122 of the hybrid charger 704 to provide additional output capability at the power supply 102.

In some examples, the input connectors 122 of the power supply 102, the hybrid charger 104, and the energy storage device 106 expose their electrical contacts in response to (e.g., during) connection of a device to the input connectors 122. For example, the input connectors 122 may include a spring-loaded door, swiveling attachment, and/or other features to cover the electrical contacts of the input connector 122 when a device is not attached. The attachment of the complementary connector 124 then triggers or actuates the cover or the contacts to move or uncover to expose the contacts for electrical connection.

In some examples, the input PFC circuitry 126, the regulated bus 128, and the isolated DC-DC converter 130 may be configured to output lower amperages to support charging connected energy storage devices 106, 706 using the input power 108. The lower amperages may be insufficient to provide welding-type output power to the power supply 102. In such examples, an operator may quickly and easily attach the charger and energy storage devices 106, 706 to the power supply 102 for easy transport and to perform welding-type operations using the energy storage devices 106, 706, but the charger is less expensive, lighter weight, and more portable.

The present methods and systems may be realized in hardware, software, and/or a combination of hardware and software. Example implementations include an application specific integrated circuit and/or a programmable control circuit.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. A hybrid welding-type system, comprising:
a welding-type power supply configured to convert input power to welding-type power, the welding-type power supply comprising an input connector configured to receive the input power; and
a hybrid charger configured to connect to the input connector of the welding-type power supply to supply the input power to the welding-type power supply using at least one of AC input power to the hybrid charger or DC input power from an energy storage device connected to the hybrid charger, wherein the energy storage device and the hybrid charger are each connectable to the same input connector.

2. The hybrid welding-type system as defined in claim 1, wherein the hybrid charger is further configured to charge the energy storage device using the AC input power while the hybrid charger is connected to the input connector of the welding-type power supply.

3. The hybrid welding-type system as defined in claim 1, wherein the hybrid charger is further configured to charge the energy storage device using the AC input power while the hybrid charger is disconnected from the input connector of the welding-type power supply.

4. The hybrid welding-type system as defined in claim 3, wherein the hybrid charger comprises a second connector configured to connect to the energy storage device.

5. The hybrid welding-type system as defined in claim 4, wherein the second connector is the same type of connector as the input connector of the welding-type power supply.

6. The hybrid welding-type system as defined in claim 4, further comprising a first adapter configured to couple the energy storage device to the input connector.

7. The hybrid welding-type system as defined in claim 6, further comprising a second adapter configured to couple the energy storage device to the second connector, the second connector being a different type than the input connector of the welding-type power supply.

8. The hybrid welding-type system as defined in claim 4, wherein the welding-type power supply is configured to receive input via a DC bus, and the hybrid charger and the energy storage device are configured to couple to the DC bus when the hybrid charger and the energy storage device are coupled to the welding-type power supply via the input connector, the second connector, and a third connector configured to couple the hybrid charger to the input connector.

9. The hybrid welding-type system as defined in claim 4, wherein the energy storage device comprises a third connector.

10. The hybrid welding-type system as defined in claim 9, wherein the third connector is a same type as the second connector.

11. The hybrid welding-type system as defined in claim 9, further comprising a second energy storage device configured to connect to each of the input connector, the second connector, and the third connector.

12. The hybrid welding-type system as defined in claim 9, wherein at least one of the second connector or the third connector is configured to expose electrical contacts in response to connection of a device to the second connector or the third connector.

13. The hybrid welding-type system as defined in claim 1, wherein the welding-type power supply comprises a DC-DC converter circuitry configured to convert the input power from DC to DC welding-type power.

14. The hybrid welding-type system as defined in claim 1, wherein the hybrid charger is configured to removably mount to the welding-type power supply.

15. The hybrid welding-type system as defined in claim 1, wherein the energy storage device is configured to removably mount to the welding-type power supply.

16. The hybrid welding-type system as defined in claim 1, wherein the hybrid charger comprises a user interface configured to output an indication of a charge state of the energy storage device.

17. The hybrid welding-type system as defined in claim 1, wherein the welding-type power supply comprises an inverter configured to convert power from the energy storage device to an AC output.

18. The hybrid welding-type system as defined in claim 1, further comprising an energy storage device adapter configured to couple the energy storage device to the input connector of the welding-type power supply.

19. The hybrid welding-type system as defined in claim 18, wherein the energy storage device adapter is configured to couple a plurality of energy storage devices to the input connector of the welding-type power supply.

20. The hybrid welding-type system as defined in claim 1, wherein the hybrid charger is configured to charge a plurality of energy storage devices simultaneously using the AC input power.
